(19) United States
(12) Patent Application Publication
(10) Pub. No.: US 2005/0005303 A1
(43) Pub. Date: Jan. 6, 2005

(54) System and method for transmitting and displaying interactive TV content

(75) Inventors: Samuel T. Barone JR., Culver City, CA (US); Drake Smith, Oxford, CT (US)

Correspondence Address: CHRISTIE, PARKER & HALE, LLP, PO BOX 7068, PASADENA, CA, 91109-7068, US

(73) Assignee: GoldPocket Interactive, Inc.

(21) Appl. No.: 10/862,783

(22) Filed: Jun. 7, 2004

Related U.S. Application Data
(63) Continuation of application No. 09/604,639, filed on Jun. 27, 2000.

(51) Int. Cl. H04N 7/173; H04N 7/025; H04N 7/10

(52) U.S. Cl. 725/110; 725/112; 725/113; 725/32

(57) ABSTRACT

A system and method are disclosed for preloading interactive content before it is to be displayed, thereby avoiding any unwanted delays due to download times. According to the invention, ITV data is embedded into the signal at some predetermined time before the corresponding segment will be broadcast. The ITV data is received by the ITV receiver, which then accesses an interactive site (web site or other server) and makes a request for the interactive content. The server determines the location of the content, and the content is then retrieved and transmitted to the ITV receiver. At the appropriate time (e.g., when the corresponding TV segment is being displayed), the content is displayed on the user's display, thereby reliably providing simultaneous display of the segment and corresponding interactive content.

### CROSS-REFERENCE TO RELATED APPLICATION(S)

This application is a continuation of application Ser. No. 09/604,639, filed Jun. 27, 2000, the disclosure of which is incorporated fully herein by reference.

### FIELD OF THE INVENTION

The present invention relates to techniques for the provision of interactive television (ITV) content associated with a television program. More particularly, the invention relates to the provision of ITV content in connection with relatively short video segments, such as TV commercials and the like.

### BACKGROUND OF THE INVENTION

Interactive television (“ITV”) combines conventional television with additional content (“interactive content”) to present a viewer with an enhanced version of a television program or commercial. Typically, the interactive content is in some way related to the television program being viewed, such as biographical information about one of the actors in the program, additional information about a topic covered in the program, and the like.

In order to experience interactive TV, a viewer must own an ITV receiver (for example, a “set-top box”, or a TV receiver that has built-in ITV receiver capabilities) that receives specially prepared video signals which include ITV data in the form of Uniform Resource Locators (“URLs”), triggers (e.g., Java-script program calls), and/or other commands. The ITV

Today, interactive television depends on World Wide Web (“Web”) technology for delivering and viewing the enhanced content. Specific web sites, addressed with URLs, are created and maintained as ITV sites. The content in these sites may be viewed with ITV receivers in the same way a computer can browse a web site. ITV receivers include web browsers, and can display downloaded content along with TV video on a conventional television set. ITV receivers obtain the majority, if not all, of the ITV web content via one of the ITV web sites, typically over a telephone line. Which sites are accessed, and how content is displayed, is determined by interactive TV links and triggers contained in the video portion of the television program. One method for encoding interactive TV links and triggers is specified in EIA-746: Transport of Internet Uniform Resource Locator (URL) Information Using Text-2 Service.

Typically, when a television program with available interactive TV content is first received, the viewer is given an option to receive the enhanced experience. If the viewer chooses the enhancements, the ITV receiver will establish a telephone connection to the Internet (if a connection is not already made), find the ITV web site based on a URL embedded in the television program, and then download the content that produces the enhanced experience.

FIG. 1. illustrates the overall signal and data flow for a conventional interactive TV system. During the production phase of a TV program or commercial, the program is edited from one or more master recordings 10, and certain URL links and command triggers are embedded, by means of a data encoder 12, into the program, for example, in the vertical blanking interval (VBI) of the video portion of the program. The modified program is recorded by a data recorder 14 for subsequent broadcast.

When desired, the TV program is broadcast, along with the embedded URLs and/or command triggers, by means of a data player 16 and broadcast station 18. These URLs and triggers cause an ITV receiver 20 in the viewer's home to retrieve enhanced content from the Internet 21 by way of a telephone interface 22. The telephone interface provides two way communication between the viewer and an ITV server 23. The telephone interface also provides the majority of the interactive content as the bandwidth reserved for ITV data in today's TV transmissions is very low. The TV program, along with the retrieved content, is displayed on a television or other display 24.

If a show or commercial is enhanced, the ITV receiver may overlay the additional text and graphics downloaded from an ITV web site on top of the video program. Those viewing the program without an ITV receiver will see the program unaltered. In the case of a television program, there is coordination between a particular episode, the corresponding web site (containing that episode's ITV content), and the URLs that are encoded into the video.

One design restraint with ITV is that, as with conventional Internet downloads, a certain minimum portion of the interactive content must be retrieved before any of the content can be displayed on the viewer's screen. Thus, the process of loading content delays the initial presentation of the interactive content.

The loading of interactive TV data may take up to tens of seconds, depending on the amount of content, the bandwidth of the connection to the ITV web site, the amount of traffic on that site, and the like. This can be somewhat problematic for a half-hour television program where it may be desirable to view the enhancement immediately; however, in the case of a 30 second commercial or other short video segment, the load time may render the enhancement unusable and therefore worthless.

In addition, the real world nature of advertising often makes it impossible to know ahead of time which commercials will be broadcast during a particular TV program. Thus, there is no way to know, at the time the program is produced, which URLs should be embedded into a program.

Thus, the need exists for a system and method whereby interactive content is available for display as soon as the corresponding video segment begins to air. In addition, the need exists for reliably determining the appropriate interactive content to be retrieved at any given time. The present invention addresses these needs.

### SUMMARY OF THE INVENTION

Briefly, the present invention is directed to a system and method for preloading interactive content before it is to be displayed, thereby avoiding any unwanted delays due to download times. According to the invention, ITV data is embedded into the TV signal at some predetermined time before the enhanceable video segment will be broadcast. The ITV data is received by the ITV receiver, which then accesses an interactive site (web site or other server) and makes a request for the interactive content corresponding to the video segment. The server determines the location of the content, and the content is then retrieved and transmitted to the ITV receiver. At the appropriate time (e.g., when the corresponding video segment is being displayed), the content is displayed on the user's display, thereby reliably providing simultaneous display of the segment and corresponding interactive content.

In another embodiment, the system of the present invention relies on a first server and one or more second servers, where the first server functions as an interface that is accessed by the ITV receivers, and where the second servers maintain the interactive content for various video segments. In response to receipt of ITV data, the ITV receiver makes a request to the first server for the appropriate interactive content. The first server determines which of the second servers maintains the corresponding content, and the second server is then contacted to retrieve the corresponding content. Such contacting of the appropriate second server can be accomplished by the first server, or alternatively by the ITV receivers directly.

### BRIEF DESCRIPTION OF THE DRAWINGS

FIG. 1 schematically illustrates a standard interactive TV system;

FIG. 2a illustrates the delay associated with displaying interactive content for a commercial utilizing a conventional method of retrieving such content;

FIG. 2b illustrates how interactive content may be displayed immediately according to one illustrative embodiment of the present invention;

FIG. 3 is a schematic diagram which illustrates a system according to one illustrative embodiment of the invention;

FIG. 4 is a schematic diagram that illustrates loading of ITV content from a known web site according to one embodiment of the invention;

FIG. 5 is a flow chart of the operational steps involved in connection with the system of FIGS. 3 and 4;

FIG. 6 is a schematic diagram that illustrates another embodiment of the invention;

FIG. 7 is a schematic diagram that illustrates loading of interactive content from a web site that was unknown when the program was produced, according to another embodiment of the invention; and

FIG. 8 is a flow chart of the operational steps involved in connection with the system of FIGS. 6 and 7.

### DETAILED DESCRIPTION OF THE INVENTION

Referring to FIGS. 2b, 3, and 4, a novel interactive system 30 is disclosed according to one illustrative embodiment of the invention. The system 30 also provides novel and unobvious functionality that is the subject of one embodiment of the present invention.

In particular, the system 30 according to one embodiment of the present invention is designed to insert a URL link, trigger, or any other suitable ITV data (hereinafter referred to as “ITV data”) in the program being broadcast, which is received by the ITV receiver 20. The ITV data is inserted into a selected frame of the TV signal which will be broadcast a selected amount of time before a corresponding TV segment will be broadcast. For example, in the case of a television commercial, the ITV data will be inserted into the TV program some selected amount of time before the commercial will begin playing, such as one minute, 30 seconds, or any other suitable amount of time before broadcasting of the commercial begins.

As described above, the ITV data can take many different forms. For example, the ITV data can be a URL, which is utilized by the ITV receiver to access the corresponding web site. Alternatively, the ITV data can be a simple trigger or other command, which commands the ITV receiver to retrieve some interactive content. In that situation, receiver 20 is programmed to access a particular web site or other information provider, and to transmit a request for content, as is described in greater detail below.

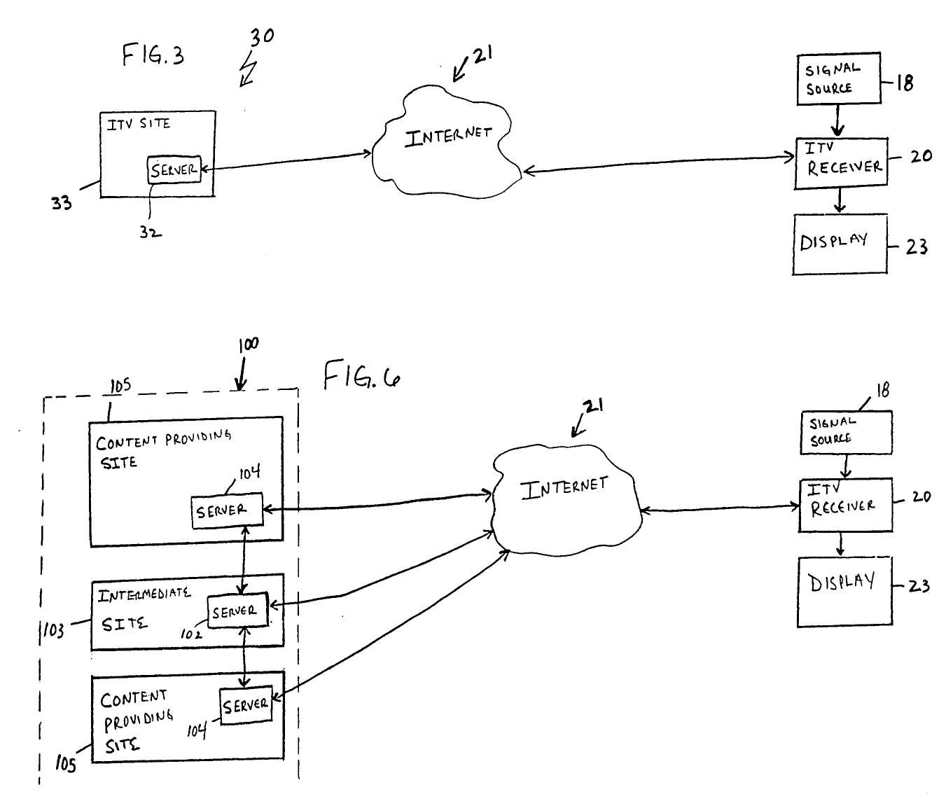

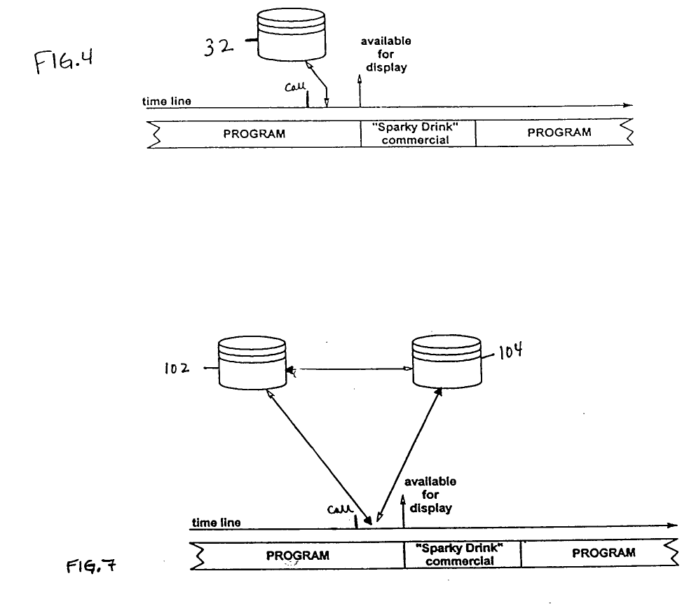

In the embodiment shown in FIG. 3, the system 30 of the present invention includes a server 32 at an ITV site 33 that is accessible by the ITV receiver 20 over the Internet 21 or other suitable communication network facility. In one embodiment, the ITV receiver is programmed to automatically establish a link with server 32 upon the receipt of any received ITV data, and to transmit a request for content. Such a request can take any suitable form, as is well known to those having ordinary skill in the art.

In the embodiment shown in FIG. 3, the system 30 of the present invention includes a server 32 at an ITV site 33 that is accessible by the ITV receiver 20 over the Internet 21 or other suitable communication network facility. In one embodiment, the ITV receiver is programmed to automatically establish a link with server 32 upon the receipt of any received ITV data, and to transmit a request for content. Such a request can take any suitable form, as is well known to those having ordinary skill in the art.

In another embodiment, the ITV data is in the form of a URL link to server 32. The URL is then used by the ITV receiver to access server 32. Simply accessing server 32 can serve as the request for content, in the case where the URL uniquely identifies corresponding content, as is described in more detail below.

As used herein, the term “interactive content” is used to refer to any additional content which is retrieved from some source other than the TV signal itself, and that is intended to be displayed with a corresponding TV program to create an enhanced program.

As used herein, the term “ITV receiver” is intended to refer to set-top boxes, digital cable boxes, or any other suitable device which has web browsing capabilities.

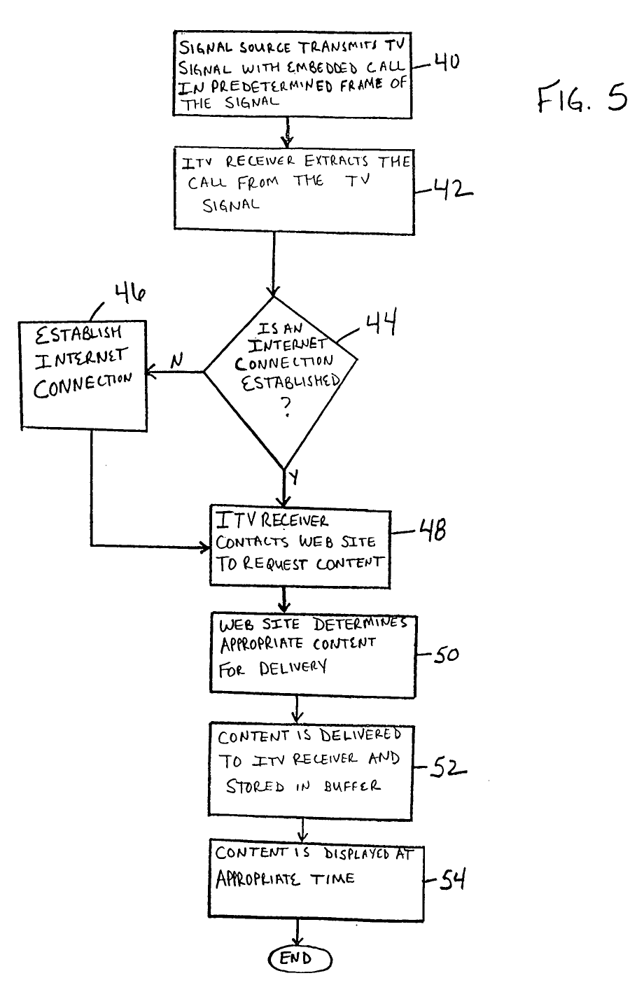

Referring now to FIG. 5, one illustrative method of the present invention is described in more detail. At step 40, the process begins with the transmission of a TV signal and embedded ITV data. At step 42, the ITV data is extracted from the TV signal by ITV receiver 20, and decoded to determine the contents of the ITV data. For example, as described above, the ITV data may be a URL link which is to be used by the ITV receiver to link with the corresponding web site 33 to retrieve the content. Alternatively, the ITV data may be in the form of a trigger (e.g., a Java-script program call) or command to request content at that time, in which case ITV receiver 20 is preprogrammed to automatically establish a link with a predetermined web site (for example, site 33) and make a request for the content. In still another embodiment of the invention, the ITV data is the actual interactive content itself, in which case the ITV receiver receives the content directly via the TV signal and display the content at the appropriate time, as described in more detail below.

At query block 44, ITV receiver 20 determines whether a connection to the Internet has already been established. If not, operation proceeds to step 46, and ITV receiver 20 establishes an Internet connection. Operation then proceeds to step 48. If at block 44, an Internet connection is already established, then operation proceeds directly to step 48.

At step 48, ITV receiver 20 contacts the appropriate site, either as directed by the URL it received, or, in the case of receipt of a trigger or command, as predetermined and programmed into the ITV receiver. ITV receiver 20 then requests the site for content. Such a request may be contained in the URL itself. For example, the URL may be to “itvlink.com/slotnumberone”. In that case, the server at itvlink.com automatically knows to retrieve the content for slot number one (e.g., the first commercial slot during a particular program).

Alternatively, ITV receiver 20 may be programmed to automatically contact the predetermined site 33 and request particular content in response to ITV data. The request may simply be for content, with the server 32 at the site 33 determining the appropriate content based on the timing of the request. Alternatively, the request may be for content for slot number 1 on a particular channel.

At step 50, site 33 determines the appropriate content for the user. This can be accomplished by accessing a look-up table or in any other suitable fashion. Then, at step 52, the site retrieves the content, and transmits it to ITV receiver 20, where it is stored in a temporary buffer or other location. At step 54, ITV receiver 20 retrieves and displays the content at the appropriate time to coincide with a corresponding TV commercial or other TV segment.

The exact timing of the ITV data will vary and depends on various factors. For example, the bandwidth of the users' connections may influence the timing. In addition, the amount of content to be downloaded is also a factor to be taken into consideration. Therefore, it will be apparent to those having ordinary skill in the art that the time of the ITV data may vary, so long as ITV receiver 20 is provided with sufficient amount of time to retrieve at least a portion of the content before the commercial is broadcast.

In the embodiment shown in FIGS. 3 and 4, server 32 is part of a web site 33 that maintains content for various commercials. Such content will typically be delivered to server 32 by the respective advertisers whose commercials are to be broadcast during a particular program. Alternatively, server 32 can create the content at the respective advertiser's instructions.

In one embodiment, the system 30 of the present invention operates in connection with the Internet. However, it will be apparent to those having ordinary skill in the art that the invention may be used in connection with any network, such as a local area network (LAN), wide area network (WAN), or any other network that allows for two-way communication of data.

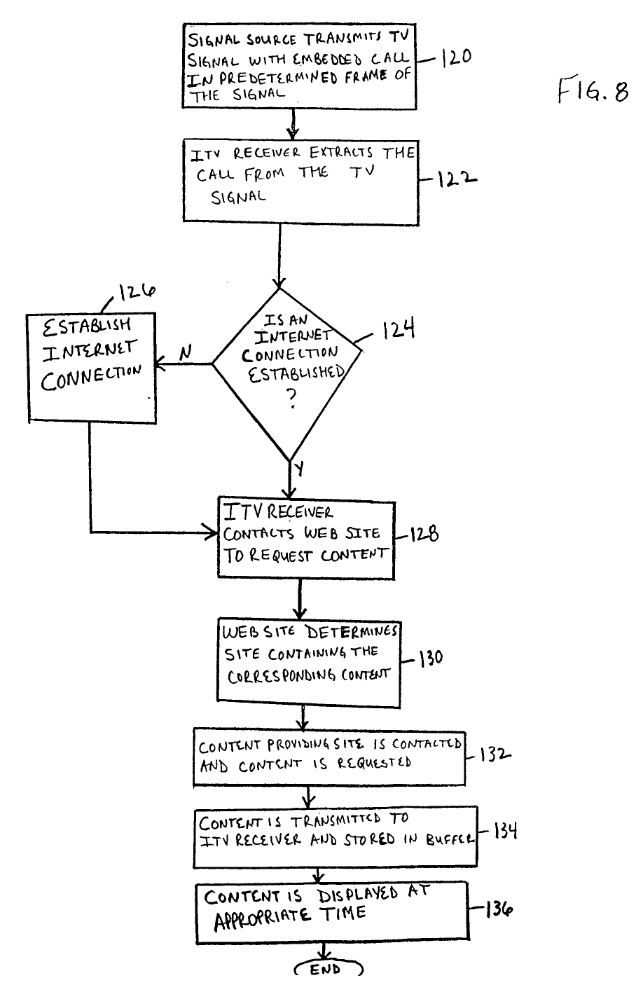

Referring now to FIGS. 6, 7, and 8, another illustrative embodiment of a system 100 and method according to the present invention is shown. In that embodiment, the system 100 includes an intermediate server 102 at a web site 103 and a plurality of content provider servers 104 at respective web sites 105.

System 100 is designed to address a problem that often results from conventional programming practices. The problem arises because it is not generally known what commercials will be broadcast along with a particular program until some time after the program is produced. Thus, since the commercials that will be broadcast are not known until after the program is produced, the corresponding URLs cannot be embedded into the TV signal during production.

Therefore, in the embodiment of FIGS. 6-8, a command, trigger, URL link to server 102, or any other suitable ITV data is embedded in the TV signal. The ITV data causes ITV receiver 20 to establish a link with intermediate server 102, which maintains a look-up table, association table, or the like, to determine the location of the appropriate content based on the particular ITV data received from ITV receiver 20.

Each content providing server 104 is identical for purposes of this discussion, and therefore only one will be described. Server 104 will typically be associated with a web site 105, and will contain interactive content for one or more commercials or other TV clips. The URL of web site 105 is stored by intermediate server 102 in its look-up table, and is linked to the ITV data received from the ITV receivers.

Referring now to FIG. 8, an illustrative method according to the invention is described. Beginning at step 120, the remote broadcast station 18 transmits a TV signal, which includes embedded ITV data. The ITV data is inserted into the signal a selected amount of time before a corresponding commercial is to be broadcast, similar to the system and method of FIGS. 3-5. As described above, the ITV data can be a specific URL or any other identifiable trigger. At step 122, ITV receiver 20 receives and decodes the ITV data, which alerts the ITV receiver that it is to retrieve some corresponding interactive content. At query block 124, ITV receiver 20 checks whether an Internet connection has been established. If not, the connection is established at step 126.

Operation then proceeds to step 128, and ITV receiver 20 establishes a link with intermediate server 102. In one embodiment, ITV receiver 20 receives a unique URL which links ITV receiver 20 with server 102. In another embodiment, the ITV receiver is programmed to automatically contact server 102 in response to receipt of a command or other trigger, and to transmit the trigger to intermediate server 102.

At step 130, intermediate server 102 determines the site that contains the corresponding interactive content. In one embodiment, the intermediate server maintains a table that links the various ITV data to the corresponding content-providing servers 104 that store the interactive content. The table may include various unique URLs that are linked to URLs of the respective content-providing servers 104. Thus, when ITV receiver 20 accesses server 102 through a unique URL, server 102 can determine, based on the URL used to access server 102, the corresponding server 104. In addition, the table may include links between triggers and commands and the corresponding URLs of content-providing servers 104. For example, a trigger to retrieve content for commercial slot 1 on channel 3 for the 7:00PM to 8:00PM program will be linked in the look-up table to a URL of a particular server 104, while a trigger to retrieve content for commercial slot 2 may be linked to a URL of another of the servers 104.

At step 132, the appropriate content-providing server 104 is contacted. This step can be performed in multiple ways. In one embodiment, the intermediate server 102 contacts server 104 directly. In another embodiment, the appropriate URL is transmitted to ITV receiver 20, which then directly establishes a link with server 104 and makes a request for content.

At step 134, the content is delivered to ITV receiver 20, where it is stored for subsequent presentation to the user. Again, the content can be delivered in many different ways. In one embodiment, server 104 transmits the content to server 102, which then forwards the content to ITV receiver 20. Alternatively, in the case where ITV receiver 20 establishes a link to server 104, the content is delivered directly to ITV receiver 20 by server 104. Or, in another embodiment, the URL of ITV receiver 20 can be provided by server 102 to server 104, with server 104 establishing the link with ITV receiver 20 to provide the content to the ITV receiver.

In any event, ITV receiver 20 is programmed to store the content in a buffer or other temporary storage location, and to retrieve the content and display it at the appropriate time, at step 136. The appropriate time can be determined by means of a clock within ITV receiver 20. Alternatively, an embedded command can be inserted into the TV signal which instructs ITV receiver 20 to begin displaying the downloaded content.

In one embodiment, the ITV data is embedded in the vertical blanking interval (“VBI”) channel of the program. However, it will be apparent to those skilled in the art that the ITV data can be inserted in any suitable manner into the TV signal, such as in any supplemental data channel in the frame.

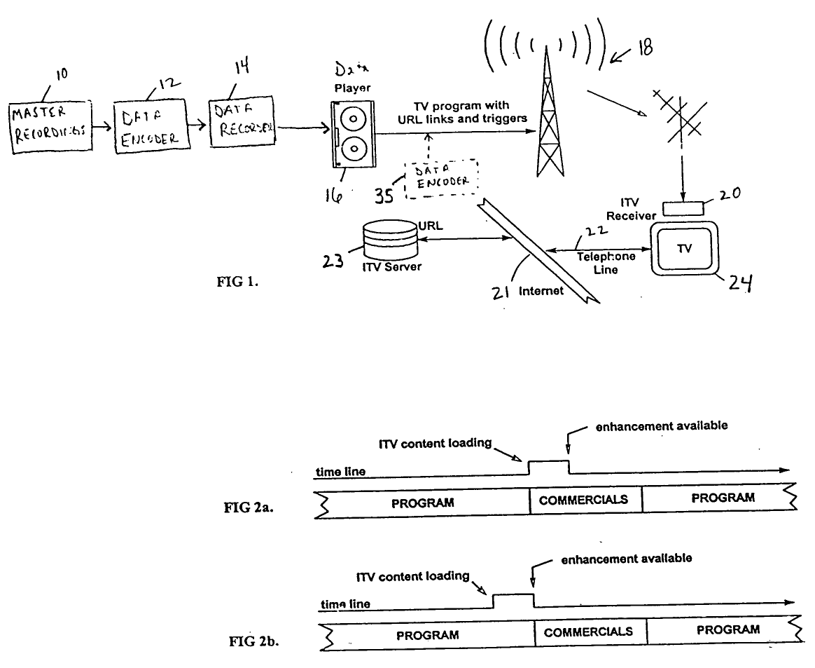

In the embodiments described above, the ITV data is embedded into the TV signal during production of the TV program. In another embodiment, an ITV encoder 35 (shown in phantom in FIG. 1) is linked to broadcast station 18, and the ITV data can be inserted into the TV signal at the time of air. The ITV data can be automatically embedded by encoder 35, or can be manually inserted by an operator via encoder 35 into the appropriate frames of the signal so as to provide the system 30 with sufficient time to download the appropriate content, as is described above.

While the system and method of the invention have been described primarily in connection with commercials, it will be apparent to those skilled in the art that the invention has utility in connection with any short program for which it is desirable to provide enhanced content, such as a particular story during a news broadcast, and the like.

While the above description contains many specific features of the invention, these should not be construed as limitations on the scope of the invention, but rather as one exemplary embodiment thereof. Many other variations are possible. Accordingly, the scope of the invention should be determined not by the embodiments illustrated, but by the appended claims and their legal equivalents.

1.-36. (Cancelled)

37. A method for synchronizing display of interactive content downloaded from a remote computer, where time taken for downloading the interactive content is inconstant, the method comprising:
receiving at a receiver a first command and a second command transmitted in a television signal, the first command being inserted at a temporal location of the signal that is received a predetermined amount of time before receipt of the second command;
automatically pre-loading from the remote computer into a data store coupled to the receiver, in response to receipt of the first command, at least a portion of the interactive content, wherein the automatic pre-loading effectively avoids delays in displaying the portion of the interactive content due delays in downloading the interactive content; and
displaying the pre-loaded portion of the interactive content in response to receipt of the second command.

38. The method of claim 37, further comprising:
accessing a web server and requesting for content;
determining at the web server the location of the first remote computer; and
retrieving the interactive content from the first remote computer.

39. The method of claim 38, wherein the retrieving the content is performed by the web server.

40. The method of claim 38, further including transmitting location information to the receiver, wherein retrieving the content is performed by the receiver.

41. The method of claim 38, wherein the remote computer is a content server accessed to retrieve the content.

42. The method of claim 41, wherein the web server accesses the content server for retrieving the content.

43. The method of claim 41, wherein the receiver accesses the content server for retrieving the content.

44. The method of claim 37, wherein the first command is inserted at the time of air.

45. The method of claim 37, wherein the first command is a URL.

46. The method of claim 37, wherein the second command is a trigger.

47. The method of claim 37, further including storing the content in the data store until receipt of the second command.

48. The method of claim 38, wherein accessing the web server comprises accessing a preselected web server.

49. The method of claim 48, further including transmitting to the preselected web server information contained within the first command.

50. The method of claim 38, wherein accessing the web server comprises accessing a particular web server based on the first command.

51. The method of claim 38, wherein requesting content comprises transmitting the first command to the interactive site.

52. A system for synchronizing display of interactive content, the system comprising:
an end user device receiving a television signal including a first command;
a first server coupled to the end user device over a communications network; and
a plurality of second servers coupled to at least one of the first server and the end user device, characterized in that the end user device retrieves the first command from the television signal and in response, transmits a first request to the first server, the first server identifying in response to the first request interactive content stored in one of the plurality of the second servers, the second server being responsive to a second request transmitted by at least one of the first server and the end user device in response to the interactive content being identified by the first server, and transmitting the identified interactive content to the end user device for display at an appropriate time.

53. The system of claim 52, wherein the first server is programmed to establish a link to the second server, the second server is programmed to transmit the identified interactive content to the first server, and the first server is programmed to transmit the identified interactive content to the end user device.

54. The system of claim 42, wherein the first server is programmed to transmit a uniform resource locator of the second server to the end user device, and the second server is responsive to receipt of the second request from the end user device to retrieve and transmit the identified interactive content to the end user device.
